(19) United States
(12) Patent Application Publication
(10) Pub. No.: US 2016/0255432 A1
(43) Pub. Date: Sep. 1, 2016

(54) ACCESSORY TO COVER THE LOWER PART OF THE FACE, THAT CAN BE ATTACHED TO COMMUNICATION HEADSETS FOR COACHES

(71) Applicant: VALOR AL CLIENTE, S.A. DE C.V., Nuevo Leon (MX)

(72) Inventor: GERARDO FERNANDO CASSO VILLAREAL, NUEVO LEON (MX)

(73) Assignee: VALOR AL CLIENTE, S.A. DE C.V., Nuevo Leon (MX)

(21) Appl. No.: 14/958,847

(22) Filed: Dec. 3, 2015

(30) Foreign Application Priority Data
Feb. 27, 2015 (MX) MX/U/2015/000112

(51) Int. Cl. H04R 1/10

(52) U.S. Cl. CPC H04R 1/105; H04R 2201/023

(57) ABSTRACT

The invention refers to an accessory to cover the lower part of the face that can be attached to the communication headsets for coaches, characterized by a covering panel that includes fixation pieces to be attached to the lateral arm of a headset, found on the inner face. Such arm can belong to the microphone that comes from an earphone up to the mouth of the user. This item covers the lower part of the face, specifically the mouth of the user, to prevent a spy from reading and interpreting the conversations held with their support technical team.

### This application claims the benefit of Mexican Application No. MX/u/2015/000112 filed Feb. 27, 2015, which are hereby incorporated by reference in their entirety as if fully set forth herein.

### INVENTION FIELD

This invention is related to the communication industry, particularly to the communication devices used for sports. More specifically, it refers to an innovative accessory to cover the lower part of the face that can be adjusted to communication headsets for coaches. Such headsets integrate earphones and microphones mounted on an extended arm adjusted to such headset, which functions as a strategic shield to cover the mouths of coaches of several sports, and avoiding lip reading when providing instructions or when talking to the support staff about the strategies to use when the team is playing.

### INVENTION BACKGROUND

In the field of joint sports, developed with teams formed by two or more people, it is really common for these players to be leaded and directed by a coach, who has more experience in the game, the rules, the strategies, the tactics, the planned plays, etc., in order to make the team work better and obtain better results through triumphs.

Many times, joint sports involve many players, in multi-player teams it is necessary for a group of coaches to be coordinated and constantly communicated, especially when other collegues that are watching the match from other areas with a wider vision of the game, or through electronic devices that avow a better view of the game and the moves to plan. That is the case of soccer, football, baseball, among others.

Specifically, when it comes to American football, it is very common to have a head coach who must be in constant communication with the other subordinate coaches, such as the coaches that coordinate the offensive and defensive lines and, in some occasions, individual positions as well as special teams, quarterback coaches, etc. The head coach is a professional who must generate game strategies and the so-called playbooks, which are reviewed by the specialized technical staff.

The coaches are located at the sidelines of the field and they decide on the team formation for every play (attack, defence and special teams) and which play must be executed, based on the formation of the opposing team or based on pre-determined plays and widely-practiced strategies. They also make decisions on the players that will be at the field, player substitution, etc., based on the plays to execute and the strengths or weaknesses of the opposing teams.

For the head coaches, the moves and strategies are key for their playing style and their success or failure, their triumphs or defeats.

The large number of players, the complexity of the game itself, the different moves, strategies, etc., compel the head coach to delegate responsibilities to other support coaches.

During a match, for the coaches to communicate with other coaches and the technical team in charge of the design of plays, strategies, etc., communication media are employed, such as microphone and earphone headsets. Nevertheless, it is very common for the opposing teams to spy on them through electronic devices, binoculars and other media, in order to read the coaches' lips and understand the indications, plays and strategies communicated to their subordinates. This allows them to warn their own coach team about such indications in order to adjust the moves or strategies and have an advantage over the other team.

To solve this situation, the coaches tend to cover their lips with their hand, with the play table or over items that avoid the visualization and lip reading by the other team so they do not access their information, indications and strategies.

This struggle led to the development of this invention, which solves the issues described above and provides a way to cover the lower part of the face, covering the mouth and preventing the opposing teams from reading or interpreting their indications, moves, strategies, etc.

### INVENTION OBJECTIVES

The main objective of this invention is to make an item to cover the lower part of the face that can be attached to communication headsets available for coaches to cover their mouths, preventing the opposing teams from reading or interpreting their indications, moves strategies, tactics, changes and orders, sent to their work team.

A different objective of the invention is to make such item to cover the lower part of the face adjustable to communication headsets available to coaches, which allows them to protect strategic and insider information in a systematic and safe way.

Another objective of the invention is to make such tern to cover the lower part of the face that can be attached to headsets or other instruments used in the communication process available to coaches, which also has a simple, practical, functional structure and is easily installed and cheap.

Another objective of the invention is to make such item to cover the lower part of the face that can be attached to communication headsets available to coaches, which can also be fully attached to the microphone arm or that can be attached and detached as an additional item or accessory.

Another objective of the invention is to make such itern to cover the lower part of the face that can be attached to communication headsets available to coaches, which is also easily handled by the coaches and avoids the use of hands or other accessories such as play charts, tablets, etc., which is intermittent and gives the opportunity to the opposing team to read their lips due to normal slips throughout the match.

And all these qualities and objectives will be apparent when providing a general and detailed description of the invention herein, supported by the graphic illustrations.

### SHORT DESCRIPTION OF THE INVENTION

In general, the item to cover the lower part of the face that can be attached to the communication headsets for coaches, according to the invention herein, consists of a covering panel that include means to be attached to a lateral arm of a headset, found on the inner face. Such arm can belong to the microphone that comes from an earphone up to the mouth of the user. This item covers the lower part of the face, specifically the mouth of the user, to prevent a spy from reading and interpreting conversations held with their support team.

In the preferred mode of the invention, such covering panel is substantially curved, which defines a substantially concave internal surface that covers the lower area of the face of the user, also covering both sides of the face.

In the preferred mode of the invention, the external surface of such covering panel defines a wide area to receive advertisements (proprietary area to be used as a part of the patent herein).

In a different mode of the invention, such covering panel is extended, as an arm to be attached to the lateral awn of a headset.

The mounting pieces of such covering panel, which are found on the internal face to mount the device on the lateral arm of a headset, are selected from a set formed by clamps, insertion slots, double-sided adhesive tape, Velcro®, clips, tongue-and-groove joints, among others.

In order to better understand the features of the invention, the description herein includes drawings, which are illustrative but not limiting, which are described below.

### SHORT DESCRIPTION OF FIGURES

FIG. 1 shows a view of a headset with the accessory to cover the lower part of the face that can be attached to communication headsets for coaches, in accordance with the invention herein.

FIG. 2 shows a conventional view of a headset with the accessory to cover the lower part of the face that can be attached to communication headsets for coaches, in accordance with the invention herein.

FIG. 3 shows a frontal view of a headset with the accessory to cover the lower part of the face in a different mode, attached to communication headsets for coaches, in accordance with the invention herein.

For a better understanding of the invention, some of the modes to use it shah be described in detail, as shown through the drawings attached to the description herein, of an illustrative and not a limiting nature.

### DETAILED DESCRIPTION OF THE INVENTION

The characteristic details of the accessory to cover the lower part of the face that can be attached to communication headsets for coaches are clearly shown through the following description and the illustrative pictures attached. The reference signs indicate the parts.

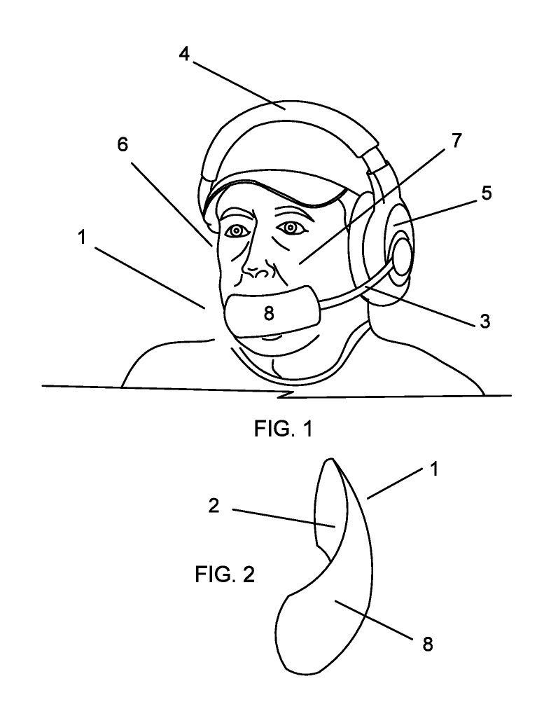

Regarding FIGS. 1 and 2, the accessory to cover the lower part of the face that can be attached to the communication headsets for coaches, consists of a covering panel 1 that include fixation pieces (not shown) to be attached to the lateral arm 3 of a headset 4, found on the inner face 2. Such arm can belong to the microphone that comes from an earphone 5 up to the mouth of the user 6. This item covers the lower part of the face 7, specifically the mouth of the user, to prevent a spy from reading and interpreting the conversations held with their support team.

Such covering panel 1 has a substantially curved shape that defines the inner surface of a substantially concave inner face 2 to cover the lower part of the user, in such a way that covers the sides of the face as wall and defines a wide area on its external face 8, which is substantially convex to receive advertisement (proprietary area to be used as a part of the patent herein).

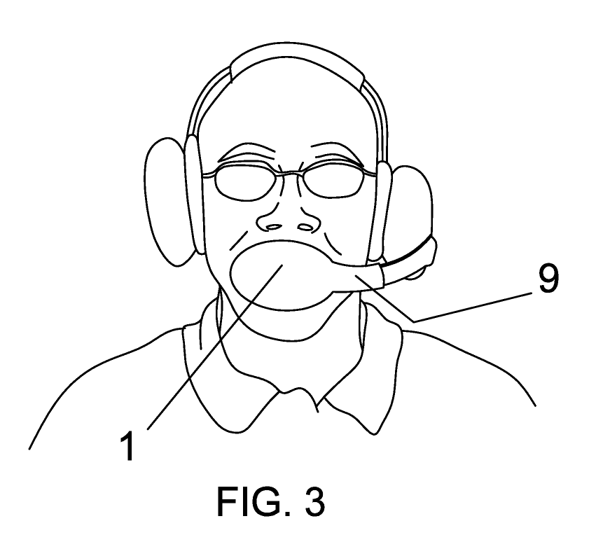

FIG. 3 shows a frontal view of the accessory to cover the lower area of the face in a different mode, which the covering panel 1 has an oblong shape and has an arm extension 9 with fixation pieces on its internal face (not shown) to be attached to the lateral arm 3 of a headset 4.

The invention has been widely described for a person with some knowledge on the subject to be able to reproduce and obtain the results mentioned in the invention herein. Nevertheless, any person with skills in the field related to the invention herein is able to make modifications what are not described in the request herein. However, if the application of such modifications in a certain structure or the manufacturing process itself requires the matters claimed in the repossession actions below, such structures must be integrated within the invention scope.

1. An accessory to cover the lower part of the face that can be attached to the communication headsets for coaches, wherein a covering panel that includes fixing pieces to be attached to the lateral arm of a headset, found on the inner face, such arm can belong to the microphone that comes from an earphone up to the mouth of the user, this item covers the lower part of the face, specifically the mouth of the user, to prevent a spy from reading and interpreting the conversations held with their support technical team, their players or their people involved in the game process.

2. An accessory according to claim 1, wherein such covering panel having a substantially curved shape that defines a substantially concave inner surface to cover the lower area of the face of the user.

3. An accessory according to claim 1, wherein the external surface of such covering panel having a wide area as a space for advertising.

4. An accessory according to claim 1, wherein such covering panel having an arm extension with fixation pieces to be attached to the lateral arm of a headset.

5. An accessory according to claim 1, wherein such fixing pieces on the covering panel being placed on the inner face to be attached to the lateral arm of a headset, selected form a set consisting of clamps, pins, insertion slots, double-sided tape, Velcro®, clips, tongue-and-groove joints, among others.
